(19) United States
(12) Patent Application Publication
(10) Pub. No.: US 2022/0061265 A1
(43) Pub. Date: Mar. 3, 2022

(54) Horse Feeding Assembly

(71) Applicants: Alon Kvashny, Lubbock, TX (US); Shari Kvashny, Lubbock, TX (US)

(72) Inventors: Alon Kvashny, Lubbock, TX (US); Shari Kvashny, Lubbock, TX (US)

(21) Appl. No.: 17/003,512

(22) Filed: Aug. 26, 2020

(51) Int. Cl. A01K 5/01

(52) U.S. Cl. CPC A01K 5/0107

(57) ABSTRACT

A horse feeding assembly for feeding a horse a variety of feeds includes a horse feeding trough that is mountable on a vertical support at a pre-determined height. In this way the horse feeding trough is positioned beneath a horse's muzzle when the horse approaches the horse feeding trough. The horse feeding trough has a plurality of feed compartments therein and each of the feed compartments has a respective one of a variety of feeds positioned therein. Thus, the horse feeding trough can simultaneously feed the horse the variety of feeds.

### (b) CROSS-REFERENCE TO RELATED APPLICATIONS

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (f) STATEMENT REGARDING PRIOR DISCLOSURES BY THE INVENTOR OR JOINT INVENTOR

Not Applicable

### (c) STATEMENT REGARDING FEDERALLY SPONSORED RESEARCH OR DEVELOPMENT

Not Applicable

### (g) BACKGROUND OF THE INVENTION

### (1) Field of the Invention

### (2) Description of Related Art including information disclosed under 37 CFR 1.97 and 1.98.

The disclosure and prior art relates to feeding devices and more particularly pertains to a new feeding device for feeding a horse a variety of feeds.

### (h) BRIEF SUMMARY OF THE INVENTION

An embodiment of the disclosure meets the needs presented above by generally comprising a horse feeding trough that is mountable on a vertical support at a pre-determined height. In this way the horse feeding trough is positioned beneath a horse's muzzle when the horse approaches the horse feeding trough. The horse feeding trough has a plurality of feed compartments therein and each of the feed compartments has a respective one of a variety of feeds positioned therein. Thus, the horse feeding trough can simultaneously feed the horse the variety of feeds.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a horse feeding assembly according to an embodiment of the disclosure.

FIG. 2 is a left side phantom view of an embodiment of the disclosure.

FIG. 3 is a top view of an embodiment of the disclosure.

FIG. 4 is a cross sectional view taken along line 4-4 of FIG. 3 of an embodiment of the disclosure.

FIG. 5 is a perspective view of an embodiment of the disclosure showing a bracket being used as a fastener.

FIG. 6 is a perspective view of an embodiment of the disclosure showing a pair of U-bolts being used as a fastener.

FIG. 7 is a perspective in-use view of an embodiment of the disclosure.

### (j) DETAILED DESCRIPTION OF THE INVENTION

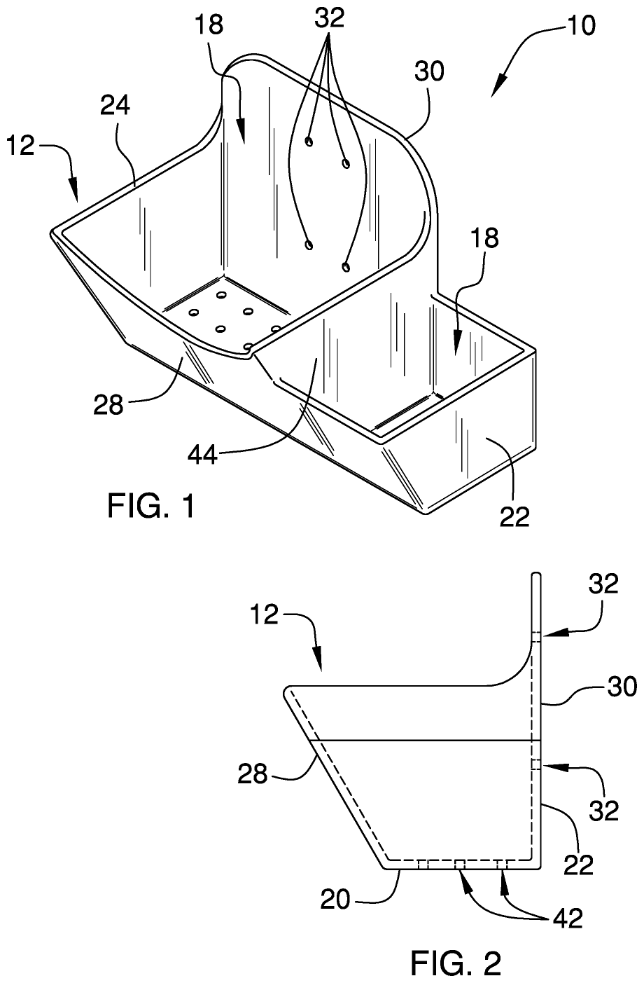

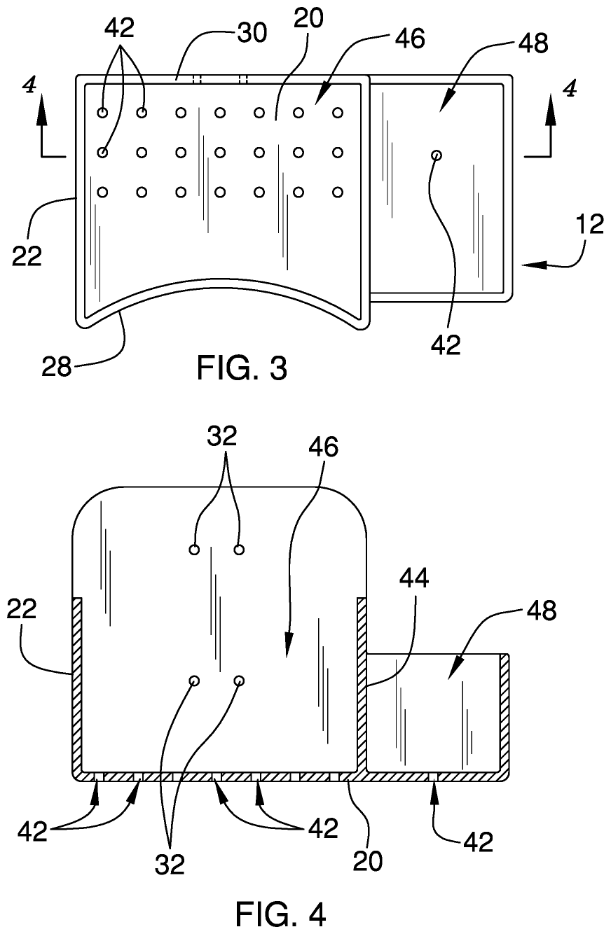

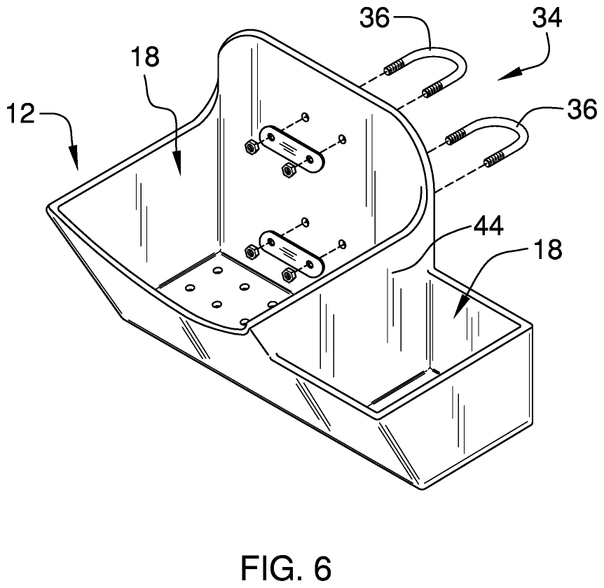

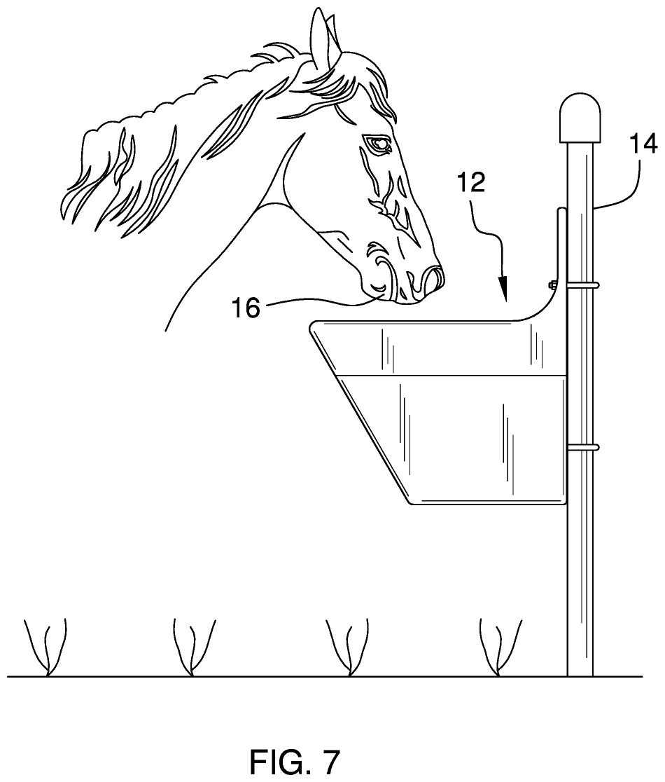

With reference now to the drawings, and in particular to FIGS. 1 through 7 thereof, a new feeding device embodying the principles and concepts of an embodiment of the disclosure and generally designated by the reference numeral 10 will be described.

As best illustrated in FIGS. 1 through 7, the horse feeding assembly 10 generally comprises a horse feeding trough 12 that is mountable on a vertical support 14 at a pre-determined height. In this way the horse feeding trough 12 can be positioned beneath a horse's muzzle 16 when the horse approaches the horse feeding trough 12. Horses generally prefer to eat with their muzzle 16 facing downwardly. Thus, the horse feeding trough 12 facilitates the horse to each with their muzzle 16 in the preferred orientation.

The horse feeding trough 12 has a plurality of feed compartments 18 therein and each of the feed compartments 18 has a respective one of a variety of feeds positioned therein. In this way the horse feeding trough 12 can simultaneously feed the horse the variety of feeds. The horse feeding trough 12 has a bottom wall 20 and a perimeter wall 22 extending upwardly therefrom, and the perimeter wall 22 has a distal edge 24 with respect to the bottom wall 20 defining an opening 26 into the horse feeding trough 12. The perimeter wall 22 has a front side 28 and a back side 30, and the front side 28 angles forwardly between the bottom wall 20 and the distal edge 24 of the front side 28 of the perimeter wall 22.

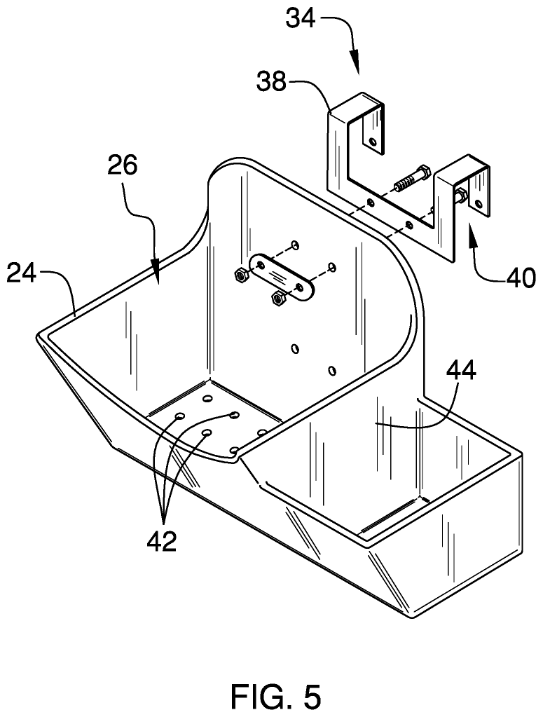

The back side 30 has a plurality of mounting apertures 32 each extending therethrough for insertably receiving fasteners 34 that engages the vertical support 14 and thusly retains the horse feeding trough 12 on the vertical support 14. The fasteners 34 may include a plurality of U-bolts 36 for attaching the horse feeder trough 12 to a post or other rounded support. As shown in FIG. 5, the fasteners 34 may include a bracket 38 that has a space 40 therein for receiving a member, such as the top rail of a fence or the like. The bottom wall 20 has a plurality of drain apertures 42 each extending therethrough for passing fluid therethrough to drain the fluid from the horse feeding trough 12. Moreover, each of the drain apertures 42 has a diameter that is sufficiently small to inhibit the feed from passing therethrough.

A divider 44 is positioned in the trough 12 to define the plurality of compartments 18, and the plurality of compartments 18 includes a hay compartment 46 and a grain compartment 48. The divider 44 extends between the front side 28 and the back side 30 of the perimeter wall 22 of the horse feeding trough 12, and the divider 44 is centrally positioned in the horse feeding trough 12. Each of the front 28 and back 30 sides of the perimeter wall 22 of the hay compartment 46 has a height that is greater than a height of each of the front 28 and back 30 sides of the perimeter wall 22 of the grain compartment 48.

The distal edge 24 of the front side 28 of the perimeter wall 22 of the hay compartment 46 is concavely arcuate with respect to the bottom wall 20. In this way the hay compartment 46 can accommodate the curvature of the horse's neck as the horse feeds from the hay compartment 46. Additionally, the front side 28 of the perimeter wall 22 of the hay compartment 46 is concavely arcuate with respect to the back side 30 of the perimeter wall 22 of the hay compartment 46. Thus, the hay compartment 46 facilitates the horse to approach the back side 30 of the perimeter wall 22 of the horse trough 12 far enough to feed with the horse's muzzle 16 facing straight down.

In use, the horse feeding trough 12 is mounted to the vertical support 14 at a height that places the horse feeding trough 12 beneath the horse's muzzle 16 when the horse approaches the horse feeding trough 12. Hay, or other type of feed, is placed in the hay compartment 46 and grain, or other similar type of feed, is placed in the grain compartment 48. In this way the horse can feed on either type of feed while in a muzzle down orientation, the most comfortable position in which a horse can feed. Additionally, the curved shape of the front side 28 of the perimeter wall 22 of the hay compartment 46 facilitates the horse to access the full depth of the hay compartment 46.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A horse feeding assembly having a plurality of feed chambers therein wherein said feeding assembly is configured to simultaneously feed horses a variety of feeds, said assembly comprising:
a horse feeding trough being mountable on a vertical support at a pre-determined height wherein said horse feeding trough is configured to be positioned beneath a horse's muzzle when the horse approaches said horse feeding trough, said horse feeding trough having a plurality of feed compartments therein, each of said feed compartments having a respective one of a variety of feeds positioned therein wherein said horse feeding trough is configured to simultaneously feed the horse the variety of feeds; and
a divider being positioned in said trough to define the plurality of feed compartments.

2. The assembly according to claim 1, wherein:
said horse feeding trough has a bottom wall and a perimeter wall extending upwardly therefrom, said perimeter wall having a distal edge with respect to said bottom wall defining an opening into said horse feeding trough, said perimeter wall having a front side and a back side, said front side angling forwardly between said bottom wall and said distal edge of said front side of said perimeter wall; and
said back side has a plurality of mounting apertures each extending therethrough wherein each of said mounting apertures is configured to have a fastener extended therethrough for engaging the vertical support and thusly retaining said horse feeding trough on the vertical support.

3. The assembly according to claim 2, wherein:
said bottom wall has a plurality of drain apertures each extending therethrough wherein each of said drain apertures is configured to pass fluid therethrough for draining the fluid from said horse feeding trough; and
each of said drain apertures has a diameter being sufficiently small wherein said plurality of drain apertures is configured to inhibit the feed from passing therethrough.

4. The assembly according to claim 2, wherein:
said divider extends between said front side and said back side of said perimeter wall of said horse feeding trough, said divider being centrally positioned in said horse feeding trough, said divider defining a hay compartment and a grain compartment;
each of said front and back sides of said perimeter wall of said hay compartment has a height being greater than a height of each of said front and back sides of said perimeter wall of said grain compartment.

5. The assembly according to claim 4, wherein said distal edge of said front side of said perimeter wall of said hay compartment is concavely arcuate with respect to said bottom wall wherein said hay compartment is configured to accommodate the curvature of the horse's neck as the horse feeds from said hay compartment.

6. The assembly according to claim 5, wherein said front side of said perimeter wall of said hay compartment being concavely arcuate with respect to said back side of said perimeter wall of said hay compartment wherein said hay compartment is configured to facilitate the horse to approach said back side enough to feed with the horse's muzzle facing straight down.

7. A horse feeding assembly having a plurality of feed chambers therein wherein said feeding assembly is configured to simultaneously feed horses a variety of feeds, said assembly comprising:
a horse feeding trough being mountable on a vertical support at a pre-determined height wherein said horse feeding trough is configured to be positioned beneath a horse's muzzle when the horse approaches said horse feeding trough, said horse feeding trough having a plurality of feed compartments therein, each of said feed compartments having a respective one of a variety of feeds positioned therein wherein said horse feeding trough is configured to simultaneously feed the horse the variety of feeds, said horse feeding trough having a bottom wall and a perimeter wall extending upwardly therefrom, said perimeter wall having a distal edge with respect to said bottom wall defining an opening into said horse feeding trough, said perimeter wall having a front side and a back side, said front side angling forwardly between said bottom wall and said distal edge of said front side of said perimeter wall, said back side having a plurality of mounting apertures each extending therethrough wherein each of said mounting apertures is configured to have a fastener extended therethrough for engaging the vertical support and thusly retaining said horse feeding trough on the vertical support, said bottom wall having a plurality of drain apertures each extending therethrough wherein each of said drain apertures is configured to pass fluid therethrough for draining the fluid from said horse feeding trough, each of said drain apertures having a diameter being sufficiently small wherein said plurality of drain apertures is configured to inhibit the feed from passing therethrough; and
a divider being positioned in said trough to define a hay compartment and a grain compartment in said horse feeding trough, said divider extending between said front side and said back side of said perimeter wall of said horse feeding trough, said divider being centrally positioned in said horse feeding trough, each of said front and back sides of said perimeter wall of said hay compartment having a height being greater than a height of each of said front and back sides of said perimeter wall of said grain compartment, said distal edge of said front side of said perimeter wall of said hay compartment being concavely arcuate with respect to said bottom wall wherein said hay compartment is configured to accommodate the curvature of the horse's neck as the horse feeds from said hay compartment, said front side of said perimeter wall of said hay compartment being concavely arcuate with respect to said back side of said perimeter wall of said hay compartment wherein said hay compartment is configured to facilitate the horse to approach said back side enough to feed with the horse's muzzle facing straight down.
